(19) United States
(12) Patent Application Publication
(10) Pub. No.: US 2015/0099038 A1
(43) Pub. Date: Apr. 9, 2015

(54) Enriched Coffee Creamer

(71) Applicant: Washica Little, Pasadena, CA (US)

(72) Inventor: Washica Little, Pasadena, CA (US)

(21) Appl. No.: 14/511,033

(22) Filed: Oct. 9, 2014

Related U.S. Application Data
(60) Provisional application No. 61/888,826, filed on Oct. 9, 2013.

(51) Int. Cl. A23C 13/12; A23C 11/00; A23C 13/14

(52) U.S. Cl. CPC A23C 13/12; A23C 13/14; A23C 11/00
USPC 426/73; 426/570; 426/564; 426/72

(57) ABSTRACT

An enriched whipped coffee creamer provides nutritional supplements and energy enhancing compounds. The enriched whipped coffee creamer includes a creamer base, a nutritional supplement, an energy enhancing source, an anti-oxidant source, and an emulsifying agent. The nutritional supplements, the energy enhancing sources, and anti-oxidant source are mixed into the creamer base. Due to the mixture naturally separating into layers, the present invention includes the emulsifying agent to lengthen the time which the mixture is homogenous. The enriched whipped coffee creamer is designed to be stored and dispensed from a canister, and barometrically pasteurized to retain the potency of the nutritional supplements at high temperatures. A propellant is used to expel the enriched whipped coffee creamer from the canister by increasing the pressure within the storage vessel. The enriched whipped coffee creamer is aerated as it exits the canister to provide a light consistency that can decorate the surface of a beverage.

The current application claims a priority to the U.S. Provisional Patent application Ser. No. 61/888,826 filed on Oct. 9, 2013.

### FIELD OF THE INVENTION

The present invention relates generally to a coffee creamer which is fortified with beneficial secondary ingredients and mixed with a propellant that aerates the creamer, and which can be added to coffee, tea, or other hot beverages.

### BACKGROUND OF THE INVENTION

Millions of people drink coffee each day, often in the morning but also in the evenings or at other times depending on a person's location and local culture. While some like their coffee plain, many others like adding creamers (either liquid or powder) or similar products to enhance the taste of the coffee. As a result, a wide variety of creamers offering a multitude of flavors have been developed. Some take the concept even further and increase the health benefits of the creamer by adding essential vitamins and nutrients, making the creamer more attractive to an increasingly health conscious public.

It is therefore an objective of the present invention to provide a coffee creamer in a viscous form, similar to whipped cream. It is a further objective of the present invention to provide a whipped natural vitamin enriched whipped coffee creamer with superfoods. The present invention also provides a whipped topping which is aesthetically pleasing and which can be used for decorative purposes. Additionally, the present invention provides health benefits due to being enriched with vitamins and other natural supplements. The present invention also reduces the need for sugar; as it is naturally sweetened, the consumer can use less sugar or sweetener in their beverages.

### BRIEF DESCRIPTION OF THE DRAWINGS

FIG. 1 is a block diagram illustrating the ingredients of the present invention.

FIG. 2 is a block diagram illustrating the ingredients of the creamer base.

FIG. 3 is a block diagram illustrating the ingredients of the nutritional supplements.

FIG. 4 is a block diagram illustrating the vitamins within the nutritional supplements.

FIG. 5 is a block diagram illustrating the ingredients of the energy enhancing source.

FIG. 6 is a block diagram illustrating the ingredients of the anti-oxidant source.

FIG. 7 is a block diagram illustrating the ingredients of the emulsifying agent.

FIG. 8 is a block diagram illustrating the ingredients of the natural sweetener.

FIG. 9 is a block diagram illustrating the ingredients of the thickening agent.

FIG. 10 is a block diagram illustrating the ingredients of the propellant.

FIG. 11 is a perspective view of an exemplary canister which the present invention is stored within and expelled from to be added to a desired beverage.

### DETAIL DESCRIPTIONS OF THE INVENTION

All illustrations of the drawings are for the purpose of describing selected versions of the present invention and are not intended to limit the scope of the present invention.

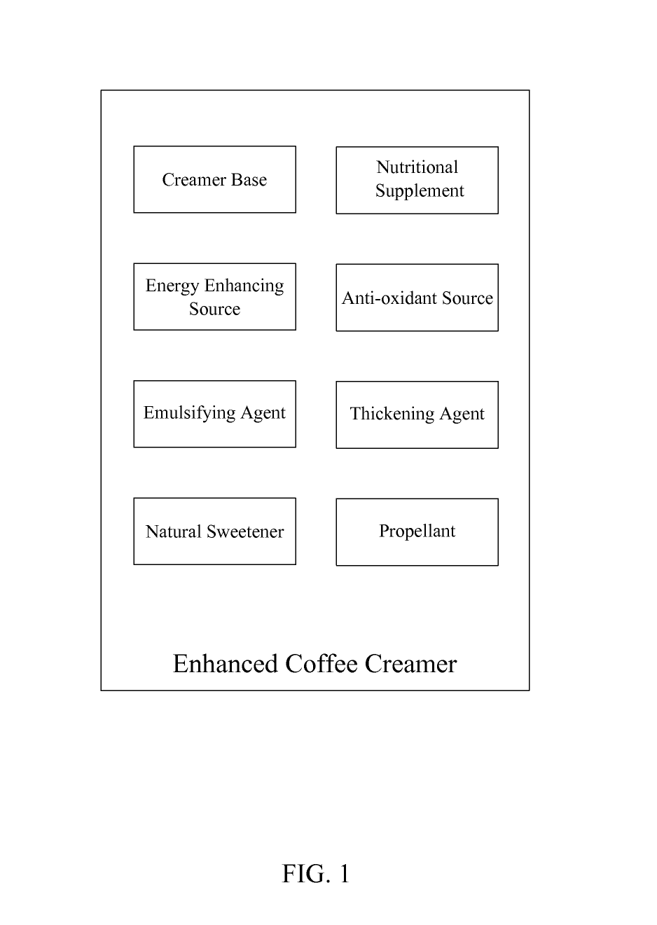

The present invention is for an enriched whipped coffee creamer which includes nutritional supplements. Coffee is a very popular beverage throughout the world. Enriching a creamer would provide drinkers with nutritional vitamins and minerals to supplement daily nutritional requirements. As shown in FIG. 1, the present invention comprises a creamer base, nutritional supplements, energy enhancing sources, anti-oxidant sources, and an emulsifying agent.

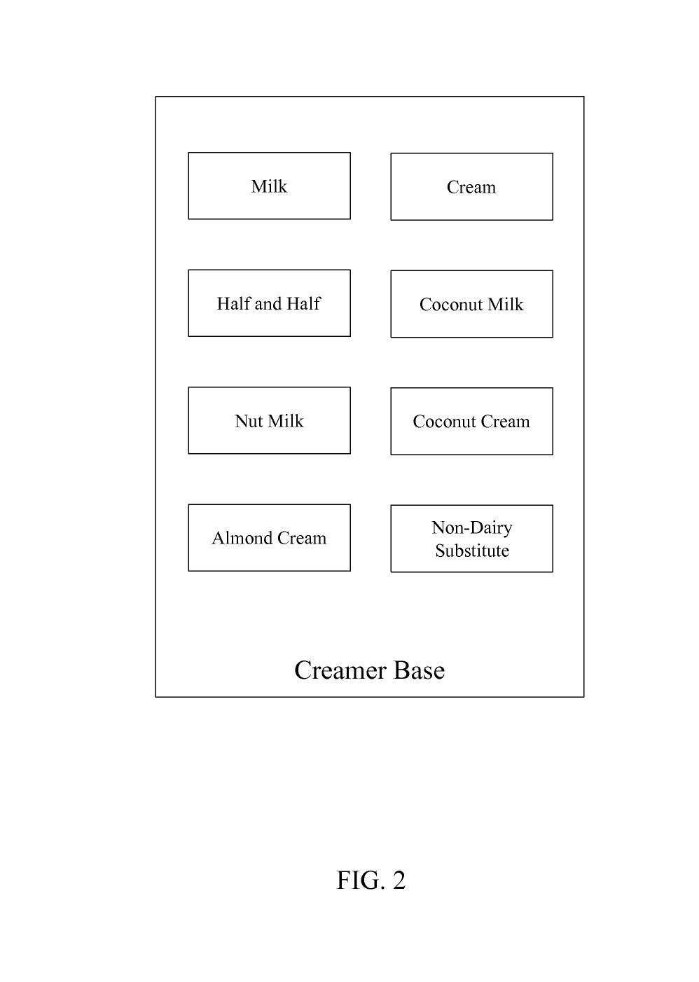

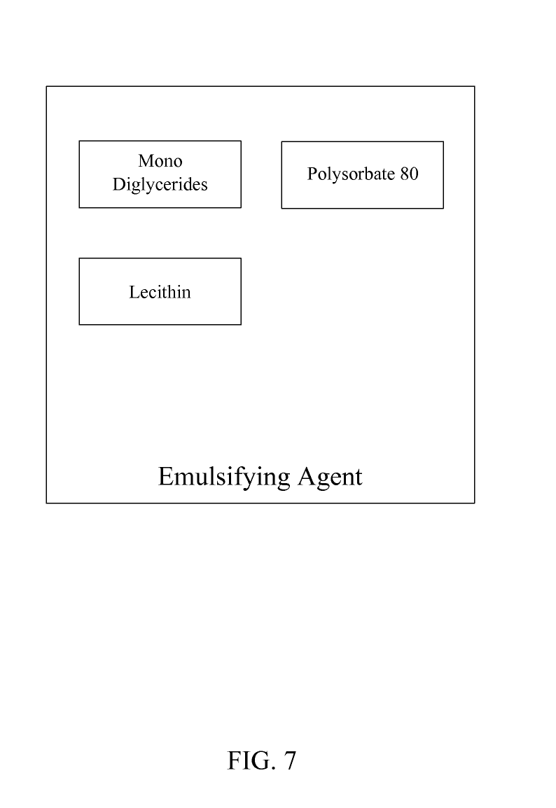

As depicted in FIG. 2, the creamer base provides a medium for the other components to be suspended in the mixture. The creamer base is fluid ingredient selected from a group consisting of milk, cream, half and half, coconut milk, nut milk, coconut cream, almond cream, and non-dairy substitutes. In the preferred embodiment of the present invention, half and half is the preferred creamer base due to the composition of the fluid. The fluid properties of the creamer base allow the aforementioned ingredients to be suspended within the volume of the creamer base for a short period of time. Over extended periods of time the ingredients may separate naturally into layers. To prevent this separation from happening too quickly, the emulsifying agent is included to bind and suspend the other ingredients for longer periods of time. The emulsifying agent is selected from a group consisting of mono diglycerides, polysorbate 80, lecithin and combinations thereof, detailed in FIG. 7.

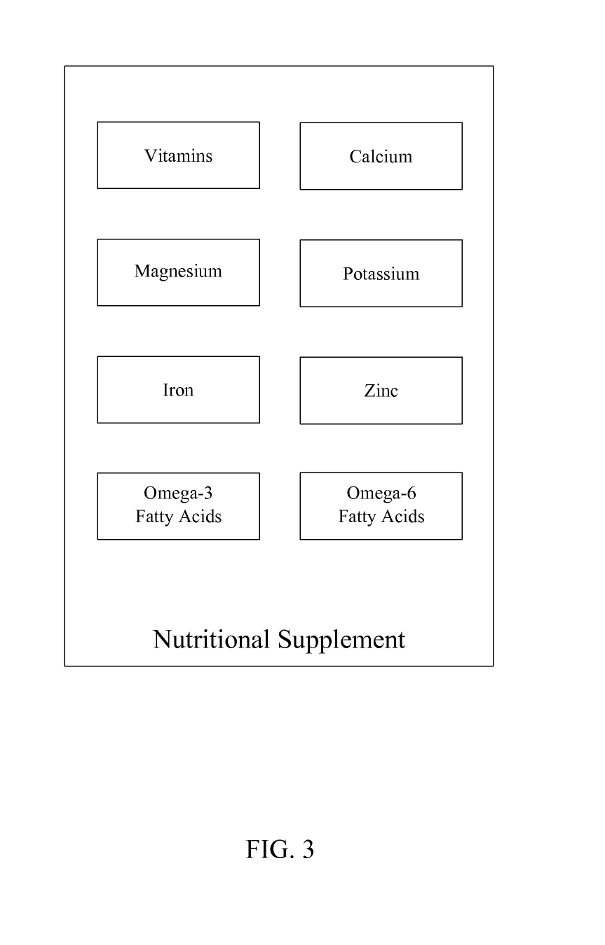

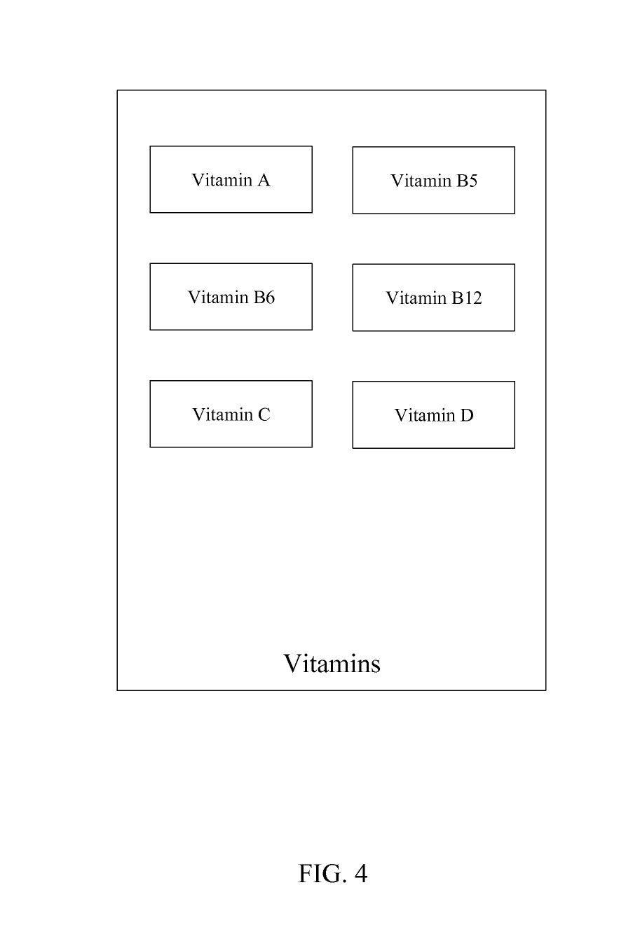

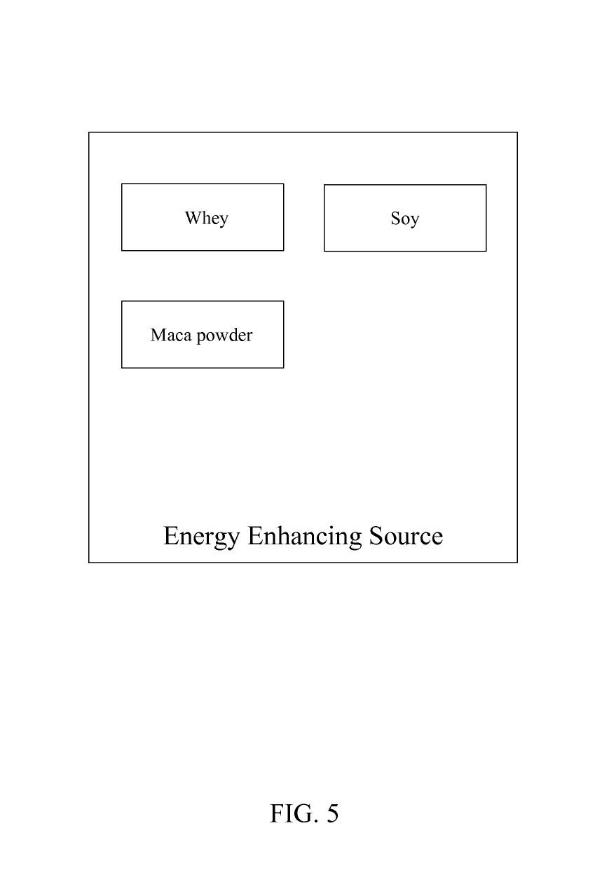

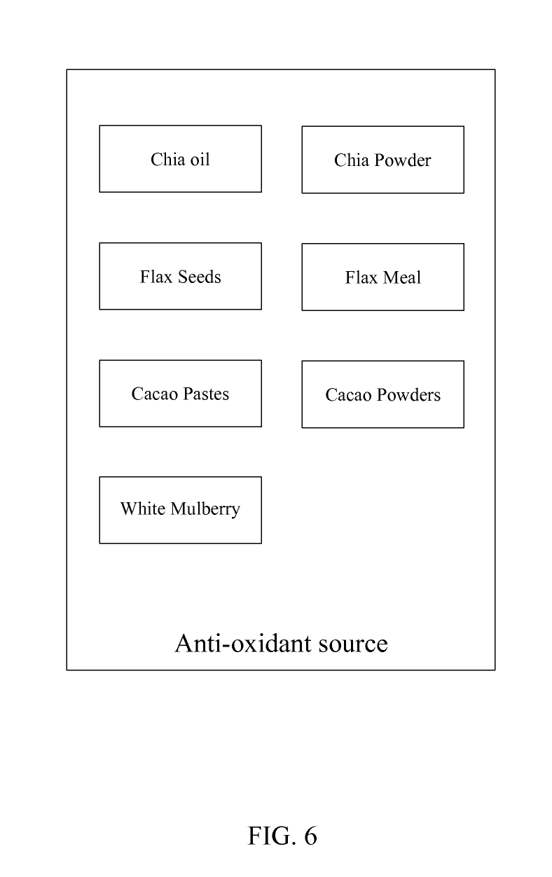

Further suspended in the creamer base are the nutritional supplements, energy enhancing sources, and anti-oxidant sources. The nutritional supplements provide several vitamins and minerals suggested for daily consumption according to the U.S. Food and Drug Administration. The nutritional supplements are selected from a group consisting of vitamins, calcium, magnesium, potassium, iron, zinc, omega-3 fatty acids, omega-6 fatty acids and combinations thereof, shown in FIG. 3. In accordance to FIG. 4, the vitamins are selected from a group consisting of vitamin A, vitamin B5, vitamin B6, vitamin B12, vitamin C, and vitamin D. It is preferred that the sources of these nutritional supplements do not include artificial additives, being provided by chia oil, chia powder, flax seed oil, flax meal, ground cinnamon, vanilla extract, chlorella powder, glucomannan, moringa powder, and mongosteen. The enriched whipped coffee creamer is barometrically pasteurized which allows the vitamins to maintain potency when the mixture is heated to temperatures that would normally decompose the vitamin compounds. The energy enhancing sources mainly provide protein to elevate energy level of the person drinking the beverage. The energy enhancing source is selected from a group consisting of whey, soy, maca powder, and combinations thereof, as shown in FIG. 5. The anti-oxidant sources provide compounds which reduce the oxidation within cells preventing damage or death the cells. Detailed in FIG. 6, these anti-oxidant sources of the preferred embodiment of the present invention are selected from a group consisting of cacao pastes, cacao powders, white mulberry, and combinations thereof.

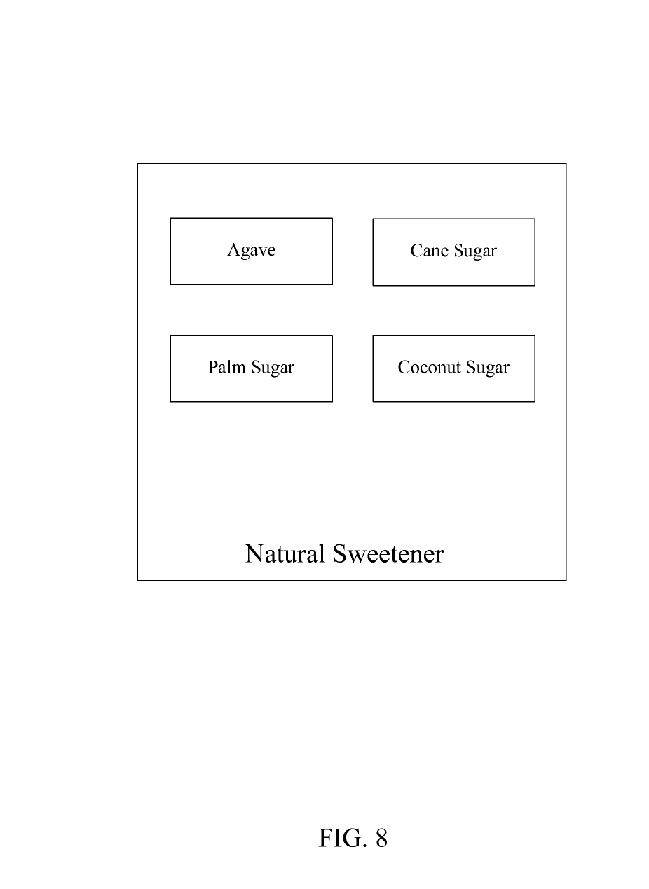

It is an objective of the present invention to provide a natural, yet flavorful and desirable, additive to coffee. One such way of providing this is from sweeteners. The present invention comprises natural sweeteners to reduce the tart and bitter taste of the natural compounds found in coffee beans. Shown in FIG. 8, the preferred natural sweeteners are selected from a group consisting of agave, cane sugar, palm sugar, coconut sugar, and combinations thereof. The palm sugar and the coconut sugar consist of a low glycemic index such that benefit diabetic users and help with weight control.

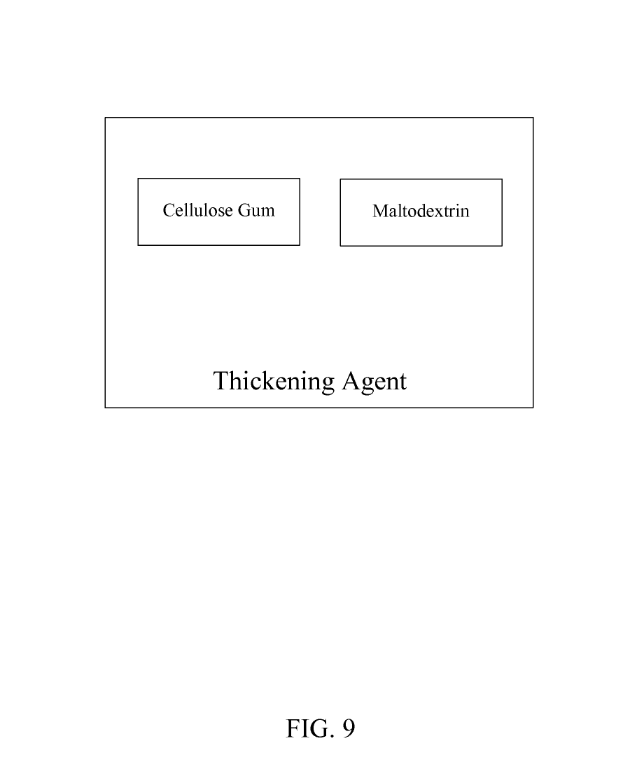

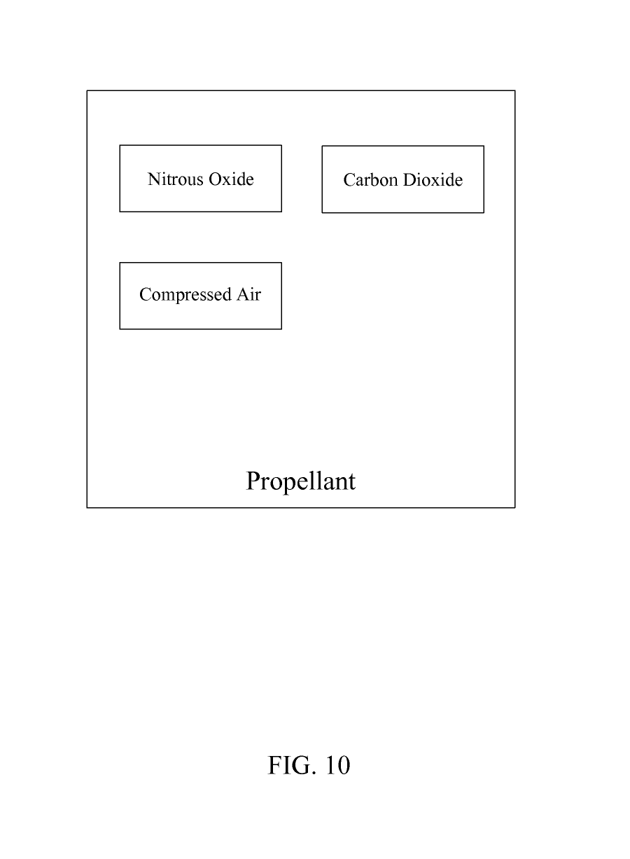

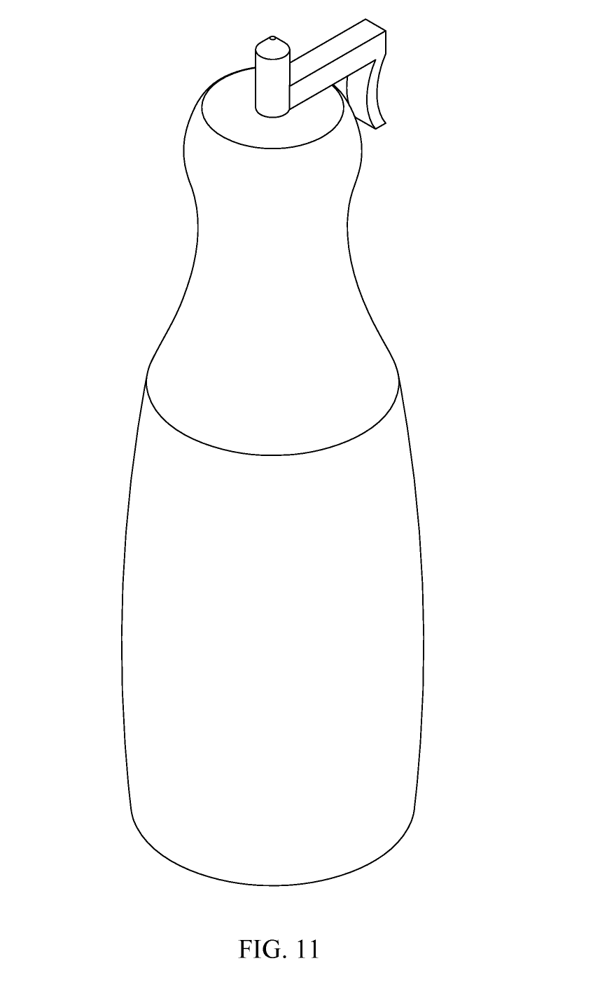

One use of the present invention is to be deposited within a pressurized aerosol canister, as shown in FIG. 11, such that the present invention can be easily and conveniently applied to a beverage. In an alternate embodiment of the present invention, the enriched whipped coffee creamer further comprises a propellant to increase pressure and expel the creamer out of the canister. The propellant is dissolved within the cream base, stored in a separate compartment within the can, or stored in an external vessel to charge the can to pressurize a primary chamber that the enriched whipped coffee creamer is stored. In accordance to FIG. 10, the propellant is selected from a group consisting of nitrous oxide, carbon dioxide, and compressed air. The propellant additionally aerates the creamer creating a whipped consistency as it exits the canister and deposited on the user's beverage. To ensure the consistency of the enriched whipped coffee creamer, one embodiment of the present invention includes a thickening agent. The thickening agent increases the viscosity of the creamer base, such that the creamer base properly aerates when exiting the canister. Detailed in FIG. 9, the thickening agent is selected from a group consisting of cellulose gum, maltodextrin, and combinations thereof. The aeration of the present invention allows for decorative and aesthetic designs to be deposited on top of a beverage. The present invention is subsequently stirred into the beverage to provide a homogeneous flavor throughout the beverage, as a traditional coffee creamer does.

The aforementioned canister stores the enriched whipped coffee creamer within a primary chamber, which is pressurized by the propellant to expel the enriched whipped coffee creamer. Several mechanisms may be used to increase the pressure of the primary chamber to aerate and expel the creamer base, including but not limited to: agitation; a secondary chamber, which is pressurized; or by an external pressure source to the primary chamber. The canister comprises a release mechanism that allows the user to open the canister. Due to the pressure from the propellant, the enriched whipped coffee creamer is expelled through the opening and onto the beverage which they desired to enhance with natural supplements. The shape of the outlet of the canister allows the propellant to aerate the creamer to a similar consistency as whipped cream. The release mechanism includes, but is not limited to, a trigger mechanism, valves, or an external pressure mechanism similar to a squeeze bottle.

Although the invention has been explained in relation to its preferred embodiment, it is to be understood that many other possible modifications and variations can be made without departing from the spirit and scope of the invention as hereinafter claimed.

What is claimed is:

1. A enriched whipped coffee creamer comprises:
a creamer base;
nutritional supplement;
energy enhancing source;
anti-oxidant source; and
an emulsifying agent.

2. The creamer base, as claimed in claim 1, being selected from the group consisting of milk, cream, half and half, coconut milk, nut milk, coconut cream, almond cream, and non-dairy substitutes.

3. The nutritional supplement, as claimed in claim 1, being selected from the group consisting of vitamin A, vitamin B5, vitamin B6, vitamin B12, Vitamin C, Vitamin D, calcium, magnesium, potassium, iron, zinc, omega-3 fatty acids, omega-6 fatty acids and combinations thereof.

4. The energy enhancing source, as claimed in claim 1, being selected from the group consisting of whey, soy, and maca powder and combinations thereof.

5. The anti-oxidant source, as claimed in claim 1, being selected from the group consisting of chia oil, chia power, flax seeds, flax meal, cacao pastes, cacao powders, white mulberry and combinations thereof.

6. The emulsifying agent, as claimed in claim 1, being selected from the group consisting of mono diglycerides, polysorbate 80, and lecithin and combinations thereof.

7. The enriched whipped coffee creamer, as claimed in claim 1, further comprises a natural sweetener.

8. The natural sweetener, as claimed in claim 7, being selected from the group consisting of agave, cane sugar, palm sugar, coconut sugar, and combinations thereof.

9. The enriched whipped coffee creamer, as claimed in claim 1, further comprises a thickening agent.

10. The thickening agent, as claimed in claim 9, being selected from the group consisting of cellulose gum, maltodextrin, and combinations thereof.

11. The enriched whipped coffee creamer, as claimed in claim 1, comprises a propellant.

12. The propellant, as claimed in claim 11, being selected from the group consisting of nitrous oxide, carbon dioxide, compressed air and combinations thereof.

13. A enriched whipped coffee creamer comprises:
a creamer base;
nutritional supplement;
energy enhancing source;
anti-oxidant source;
an emulsifying agent;
a natural sweetener;
a thickening agent; and
a propellant.

14. The creamer base, as claimed in claim 13, being selected from the group consisting of milk, cream, half and half, coconut milk, nut milk, coconut cream, almond cream, and non-dairy substitutes.

15. The nutritional supplement, as claimed in claim 13, being selected from the group consisting of vitamin A, vitamin B5, vitamin B6, vitamin B12, Vitamin C, Vitamin D, calcium, magnesium, potassium, iron, zinc, omega-3 fatty acids, omega-6 fatty acids and combinations thereof.

16. The enriched whipped coffee creamer, as claimed in claim 13, comprises:
the energy enhancing source being selected from the group consisting of whey, soy, and maca powder and combinations thereof; and
the anti-oxidant source being selected from the group consisting of chia oil, chia power, flax seeds, flax meal, cacao pastes, cacao powders, white mulberry and combinations thereof.

17. The emulsifying agent, as claimed in claim 13, being selected from the group consisting of mono diglycerides, polysorbate 80, and lecithin and combinations thereof.

18. The natural sweetener, as claimed in claim 13, being selected from the group consisting of agave, cane sugar, palm sugar, coconut sugar, and combinations thereof.

19. The thickening agent, as claimed in claim 13, being selected from the group consisting of cellulose gum, maltodextrin, and combinations thereof.

20. The propellant, as claimed in claim 13, being selected from the group consisting of nitrous oxide, carbon dioxide, compressed air and combinations thereof.
